(19) United States
(12) Patent Application Publication
(10) Pub. No.: US 2011/0029291 A1
(43) Pub. Date: Feb. 3, 2011

(54) Method for fracture surface extraction from microseismic events cloud

(76) Inventors: Xiaowei Weng, Katy, TX (US); Olga Kresse, Sugar Land, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/462,244

(22) Filed: Jul. 31, 2009

(51) Int. Cl. G06F 17/10; G06G 7/48

(52) U.S. Cl. 703/2; 703/10

(57) ABSTRACT

Embodiments of this invention relate to a method for analysing data related to subterranean formations including collecting data from microseismic observations of a subterranean formation that is stored on a device, analysing the data using a tensor voting method, and providing an estimate of a surface of a subterranean formation. Embodiments of this invention relate to a method for analysing data related to subterranean formations including collecting data from microseismic observations of a subterranean formation, analysing the data using a tensor voting method, providing an estimate of a surface of a subterranean formation, and tailoring an aspect of an oil field service in response to the estimate.

### BACKGROUND

1. Field

This invention relates to methods to model a subterranean formation. In particular, the invention relates to methods for modeling surfaces of fractures within a subterranean formation.

2. Description of the Related Art

Hydraulic fracturing is one of the most widely used technologies for stimulating oil and gas production from a low permeability formation to increase hydrocarbon production. During a hydraulic fracture treatment, a fracturing fluid is injected at a pressure exceeding the in-situ stress of the target formation to create a large fracture. In a competent rock formation that does not contain extensive natural fractures, it is commonly believed that a single dominant fracture is created in the direction perpendicular to the minimum in-situ stress. The resulting fracture, filled with propping agent carried by the fluid, provides a highly conductive conduit to facilitate the flow of hydrocarbon into the wellbore.

In recent years, microseismic monitoring has been widely used in hydraulic fracture treatments to help determining the dimensions of the hydraulic fracture created. During the hydraulic fracturing process, due to the stress increase and fluid filtration in the region surrounding the fracture, the natural fractures or faults commonly existing in the formation undergo slippages along the natural fracture planes, triggering a series of small magnitude seismic waves traveling in the formation, called microseismic events. These microseismic events can be detected by a string of geophones located in a neighboring well. By processing the detected acoustic wave forms, the epicenter of each microseismic event can be determined. Collectively, the detected event locations form a cloud that envelopes the actual fracture being created. Based on the shape of the microseismic cloud, engineers can estimate the length and height of the hydraulic fracture. Human judgment is often relied upon to exclude isolated or sparse events in this exercise, leading to large uncertainties in the inferred fracture dimensions.

With increasing application of hydraulic fracturing in formations such as fractured shales, microseismic monitoring provided evidences that complex hydraulic fracture networks are created in a highly naturally fractured formation. While manual extraction of the fracture shape from a microseismic cloud is possible, which is quite challenging and highly uncertain in itself, real time interpretation of microseismic events demands a robust and automated fracture extraction method.

### SUMMARY

Embodiments of this invention relate to a method for analyzing data related to subterranean formations including collecting data from microseismic observations of a subterranean formation that is stored on a device, analyzing the data using a tensor voting method, and providing an estimate of a surface of a subterranean formation. Embodiments of this invention relate to a method for analyzing data related to subterranean formations including collecting data from microseismic observations of a subterranean formation, analyzing the data using a tensor voting method, providing an estimate of a surface of a subterranean formation, and tailoring an aspect of an oil field service in response to the estimate.

### BRIEF DESCRIPTION OF THE DRAWING

FIG. 1 is a schematic diagram of a general saliency tensor.

FIGS. 2A, 2B, and 2C are a plot of data collected from Example 1—Microseismic events cloud and extracted fracture.

FIGS. 3A, 3B, and 3C are a plot of data collected from Example #1—Microseismic (MS) event cloud and extracted fracture surface

FIGS. 4A and 4B a plot of data collected from Example #2—Microseismic events cloud and extracted fracture surface for different value of scaling parameter.

FIGS. 5A and 5B are a plot of data collected from Example #2—Another perspective of the same microseismic events cloud (21093 events or points) and extracted fracture surface.

FIGS. 6A and 6B are a plot of data collected for Example #3—Microseismic event cloud and extracted fracture surface for conventional reservoir.

### DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments of the invention and should not be construed as a limitation to the scope and applicability of the invention. In the summary of the invention and this description, each numerical value should be read once as modified by the term “about” (unless already expressly so modified), and then read again as not so modified unless otherwise indicated in context. A method of fracture surface extraction from a microseismic cloud using tensor voting method is described. The method allows automated inference of complex fracture features without presumption of a single planar fracture as it is done today.

The tensor voting method deals with three types of data:
Points, represented by their coordinates;
A segment of a curve, represented by the point coordinates, and its associated tangent or normal;
A surface patch, represented by the point coordinates, and its associated normal.

For microseismic processing, coordinate points are the most easily obtained type of data.

To represent general first order geometric features, including a surface, a second order symmetric tensor is used. It captures both the orientation information and its confidence, or saliency. Intuitively, the shape of the tensor defines the type of information captured (point, curve, or surface element), and its size represents the saliency. By saliency, the perceived importance or confidence of the probable structures such as surfaces, curves, junctions and regions are determined. For instance, a point on a smooth surface is represented by a tensor in the shape of an elongated ellipsoid (stick tensor) with its major axis along the surface normal.

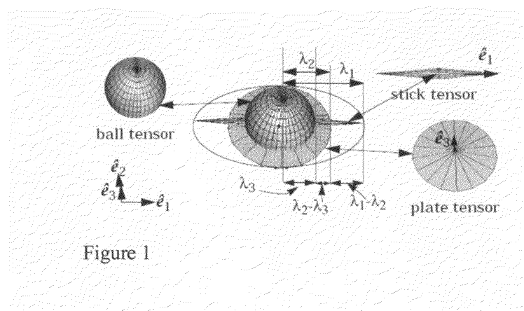

The input tokens are first encoded as tensors. A point is encoded as a 3-D ball tensor. For the purpose of coherent feature extraction, a saliency field can be computed using the tensor voting procedure. At any given point, votes are casted by all other data points using voting fields derived from the fundamental 2-D stick voting kernel developed by Medioni et al. The magnitude of the vote decays with distance and curvature according to the following equation:

$$V ( d , ρ ) = {e}^{- \frac{{d}^{2} + c {ρ}^{2}}{{σ}^{2}}}$$

where d is the distance along the smooth path (arc length), ρ is the curvature of the path and σ is the scale of the voting field that essentially controls the size of the voting neighborhood and the strength of the votes. Vote accumulation is performed by tensor addition or equivalently by addition of 3×3 matrices (in the 3-D case), therefore it is computationally inexpensive. Surfaces are extracted as the local maxima of surface saliency field. FIG. 1 is a schematic diagram of a general saliency tensor.

A challenging issue is the proper selection of the scale of voting field, σ. As the sole free parameter in this framework, scale indeed plays a significant role in determining the quality of the inference results. Poor selection of scale can lead to very unrealistic feature extraction.

An integral component of embodiments of the present invention is a method for proper selection of the scale parameter based on the dimension of the microseismic cloud to achieve a consistent and representative fracture surface extraction.

In some embodiments, a device may be selected to perform the mathematical analysis such as a computer, memory device, hard drive, server, handheld device, or a combination thereof. The information from the mathematical analysis may be used for adjusting an aspect of an oil field service based on the estimate of the surface of a subterranean formation. In fact, in some embodiments, the surface of the subterranean formation is an outline of a hydrocarbon deposit.

The ability of the tensor voting method to extract complex fracture geometry can be illustrated in the following examples.

### EXAMPLES

The following examples are presented to illustrate the ability of the current invention of using tensor voting method to extract complex fracture geometry from microseismic events cloud. The quality of fracture surface extraction is influenced by the accuracy of the microseismic event locations determined by microseismic wave detection and processing software. The accuracy of the data processing technique will further improve over time and hence enhance the quality of fracture surface extraction. The examples presented below represent the microseismic data obtained from the current technology and specific rock formations and fracture treatments conducted, and should not be construed to limit the scope of the invention, unless otherwise expressly indicated in the appended claims.

### Example #1

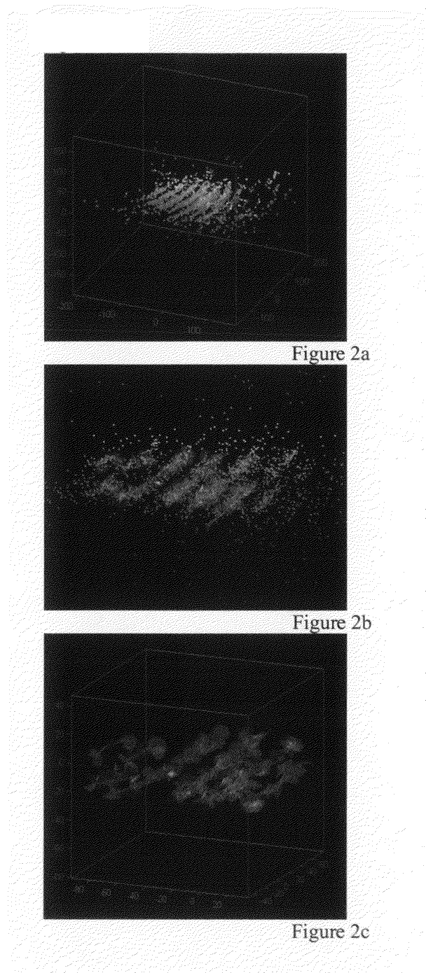

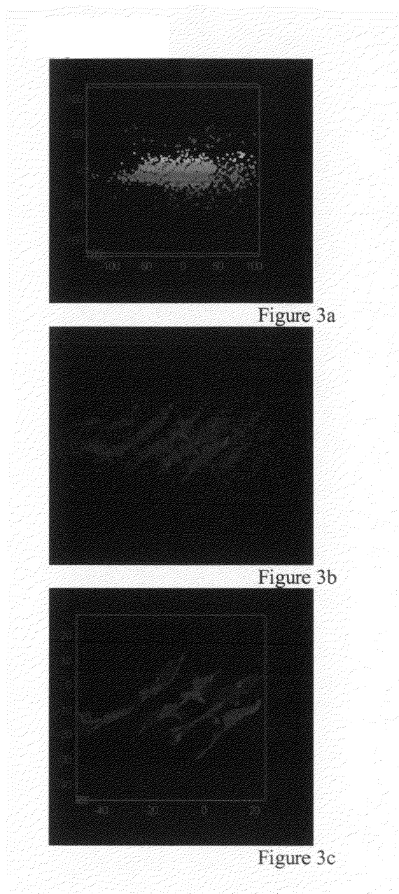

FIG. 2A shows the microseismic events cloud obtained during a hydraulic fracture treatment. FIG. 2B shows MS event cloud and extracted fracture surface, and FIG. (2C) shows only extracted fracture surface for data scaled by 5, and for small value of scaling parameter sigma (equal to 5). Because of values of scaling parameter, the extracted surface is more detailed and not planar. FIGS. 3A and 3B show the same microseismic event cloud but scaled with higher value of scaling parameter. It represents microseismic events cloud (FIG. 3A), MS event cloud and the extracted fracture surface (FIG. 3B), and extracted fracture surface (FIG. 3C) when MS data coordinates are scaled by 8. Because of larger scaling parameter, the extracted surface is more planar. These examples demonstrate the ability of tensor voting method to extract fracture surface features, and importance of data scaling for desired (more realistic) surface extraction. With the tensor voting method, the features are extracted solely based on the coherent relations or saliency among the event locations. No presumption of fracture feature (e.g. a single plane) is made.

### Example #2

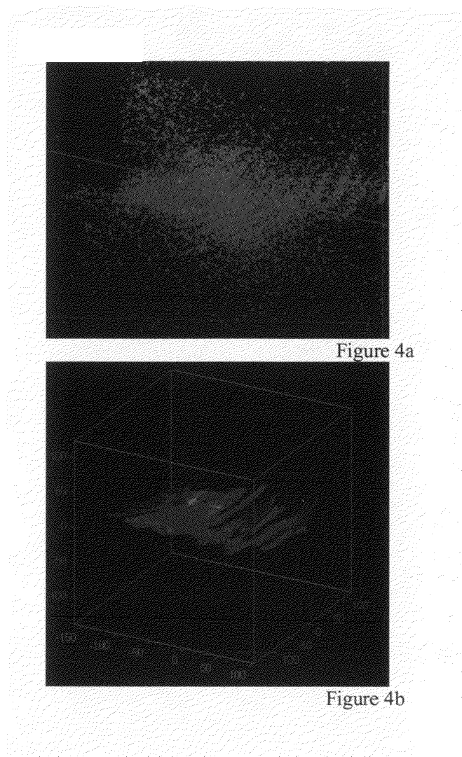

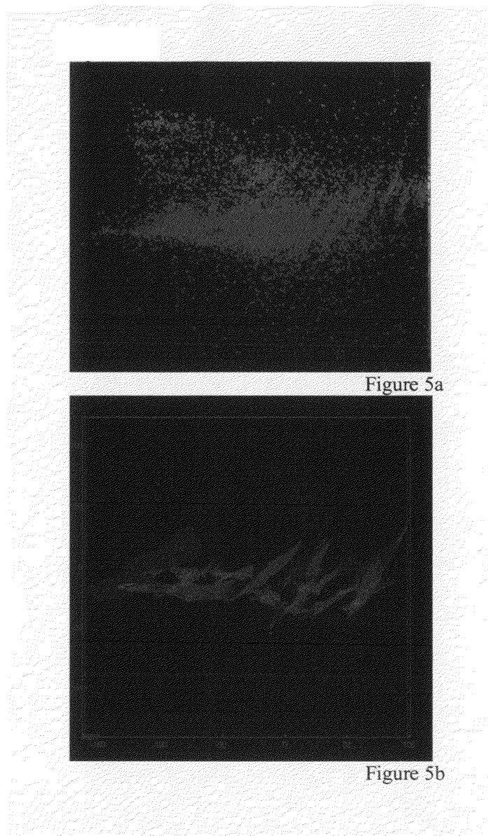

This is another example showing the original data cloud (FIG. 4A) in complex formation and the extracted fracture surfaces (FIG. 4B) with scale of voting field equal to 20. Using larger scale of voting field sigma allows to extract more planar fracture surface which fits well into the microsiesmic cloud of 21093 events (points). FIGS. 5A and 5B represent another angle of the same cloud of 21093 events (FIG. 5A), and extracted fracture surface (FIG. 5B).

### Example #3

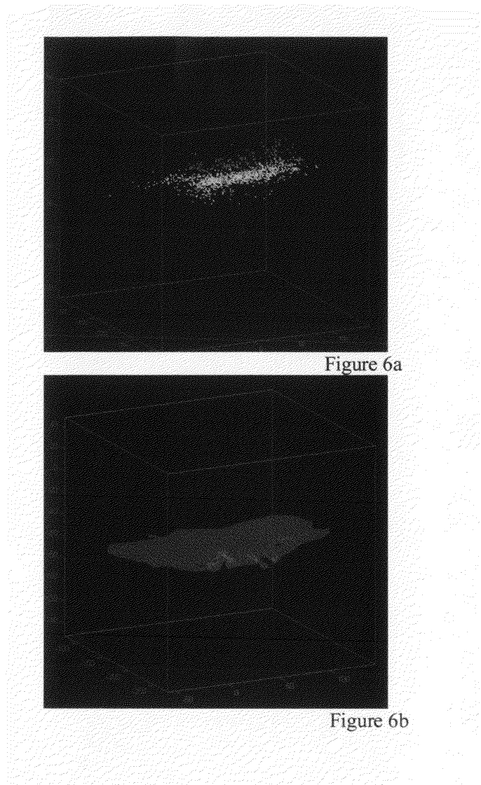

FIGS. 6A and 6B illustrate Example 3. This example shows the original microseismic event cloud of 1633 events (FIG. 6A) in conventional (without natural fractures) reservoir and extracted planar fracture surface (FIG. 6B). For hydraulic fracturing in conventional reservoirs the expected generated fracture is a single planar fracture. This example demonstrates the ability of tensor voting methods to extract fracture surfaces in conventional reservoirs.

The particular embodiments disclosed above are illustrative only, as the invention may be modified and practiced in different but equivalent manners apparent to those skilled in the art having the benefit of the teachings herein. Furthermore, no limitations are intended to the details herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method for analysing data related to subterranean formations, comprising:
collecting data from microseismic observations of a subterranean formation that is stored on a device;
analysing the data using a tensor voting method; and
providing an estimate of a surface of a subterranean formation.

2. The method of claim 1, wherein the data collected is a microseismic event cloud.

3. The method of claim 1, wherein the data collected is points, a segment of a curve, a surface patch, or a combination thereof.

4. The method of claim 1, wherein the data is represented by coordinates; point coordinates and point coordinates tangent or normal; point coordinates and a surface patch associated normal; or a combination thereof.

5. The method of claim 1, wherein the microseismic observations are a microseismic cloud.

6. The method of claim 1, wherein the device is a computer, memory device, hard drive, server, handheld device, or a combination thereof.

7. The method of claim 1, wherein the tensor voting method comprises using a second order symmetric tensor

8. The method of claim 7, wherein the second order symmetric tensor comprises the orientation information and its saliency.

9. The method of claim 1, wherein the tensor voting method comprises selecting a scale of voting field based on the dimension of the microseismic cloud.

10. The method of claim 1, further comprising adjusting an aspect of an oil field service based on the estimate of the surface of a subterranean formation.

11. The method of claim 1, wherein the surface of the subterranean formation is an outline of a hydrocarbon deposit.

12. A method for analysing data related to subterranean formations, comprising:
collecting data from microseismic observations of a subterranean formation;
analysing the data using a tensor voting method;
providing an estimate of a surface of a subterranean formation; and
tailoring an aspect of an oil field service in response to the estimate.

13. The method of claim 12, wherein the tensor voting method comprises using a second order symmetric tensor.

14. The method of claim 13, wherein the second order symmetric tensor comprises the orientation information and its saliency.

15. The method of claim 12, wherein the tensor voting method comprises selecting a scale of voting field based on the dimension of the microseismic cloud.

16. The method of claim 12, wherein the surface of the subterranean formation is an outline of a hydrocarbon deposit.
